(19) United States
(12) Patent Application Publication
(10) Pub. No.: US 2024/0216195 A1
(43) Pub. Date: Jul. 4, 2024

(54) Personal Lift Chair

(71) Applicant: Roger Joseph Voorhis, Jr., Clarksville, TN (US)

(72) Inventor: Roger Joseph Voorhis, Jr., Clarksville, TN (US)

(21) Appl. No.: 18/147,182

(22) Filed: Dec. 28, 2022

(51) Int. Cl. A61G 5/14

(52) U.S. Cl. CPC A61G 5/14

(57) ABSTRACT

A compact light weight personal lift chair assists user in transferring from a floor setting position to an upright standing position on a floor. The personal lift chair resides in a collapsed/deflated position configuration at floor level enabling easy slide-on access and includes a chair with handles for support during the lift process. The personal lift chair utilizes an air pump filling a single cylindrical airbag/bladder, elevating the lift chair seat from floor to a raised standing position. An auto-latching mechanism locks the chair into the fully elevated/inflated position as a safety precaution, preventing unintentional deflation of the airbag/bladder. The personal lift chair utilizes three vertical guide rails around the single elevating airbag/bladder raising the chair seat. The supporting framework includes a small angle that tilts the slightly inclined chair seat forward providing easy exiting from the chair seat to a standing position at the fully inflated position.

A personal lifting chair that has the function of lifting a person from the floor level to a standing position. This is designed to assist people that have fallen and are physically uninjured and would normally require assistance to get back to their feet. The device is intended for limited use under the conditions mentioned. The lift seat in the normal position is approximately 1-3 inches above the floor and will rise to approximately 22-24 inches above the floor enabling the person to get back to their feet. The chair is facilitated with an operating control and arm rest to provide support during the lifting process. The lift chair is designed for lifting users weighing up to 400 lbs. The lift chair light weight permits the lift chair to be mobile for voice controlled/operated relocation to site where user requires assistance from a fall.

### DESCRIPTION OF THE RELATED ART

Many individuals suffer from limited mobility because of disease, decreased muscle and joint strength, advanced age or disability. A common problem exists for such people when they are required to move from the floor to an upright vertical position to regain walking mobility. An individual may have fallen or may have voluntarily moved to a sitting position on the floor and are unable to return to a vertical/standing upright position. The uninjured fall is an obvious situation, but other situations exist that are limitation for the disabled. For example, a person has voluntarily placed him or herself down on the floor to perform a variety of tasks.

Existing devices are bulky, limited in stability and unwieldy, generally being designed for a commercial oriented medical institution (with assistance), hospitals or other specific environment making them unusable for a home, personal or residential application. The device described herein is particularly designed to be operable by the user without the necessity for assistance from additional personnel. The device described herein is also significantly reduced in weight, operational complexity, and design complexity with fewer moving parts. The design is not precluded from use in a commercially oriented medical institution, as it will function as required.

The above-described deficiencies of systems that are available are intended to provide an overview of some of the problems of conventional systems and not intended to be an extensive review. Additional limitation and benefits with the currently available designs in this non-limiting embodiment may become apparent in review of the detailed description included.

In view of the foregoing, it is desirable to provide a personal lift chair that is easily placed in a residential or commercial application or easily operated by the user, light weight enabling easy positioning and not limited to this specific application or location.

### BRIEF SUMMARY OF THE INVENTION

Disclosed is a personal lift chair for assisting a user in transitioning from a floor seated position to an upright standing position using a single pneumatic cylindrical airbag/bladder and a stabilizing guide rail frame. The device is a compact and lightweight configuration suitable for easy location and storage and can include wheels allowing it to be easily moveable for location within the user facility or residence. The device utilizes a single elevating airbag/bladder to raise the chair seat from the floor to an elevated or raised position. The supporting frame includes a small forward tilt angle to assist a user in translating from a seated to a standing position. The personal lift chair seat includes a small forward angle to assist in easy entrance at floor level and easy exit at standing level. The airbag/bladder elevates the chair seat to a height that is sufficient to enable the user to have the legs extended under the user's body, without a knee bend, enabling the standing position.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 Perspective view of Lift chair device in accordance with the principles of invention.

FIG. 2 Frontal elevation view of personal lift chair with the principles of invention.

FIG. 3 Side elevation assembly view of personal lift chair with the principles of invention.

FIG. 4 Side elevation view of personal lift chair supporting frame with principles of invention.

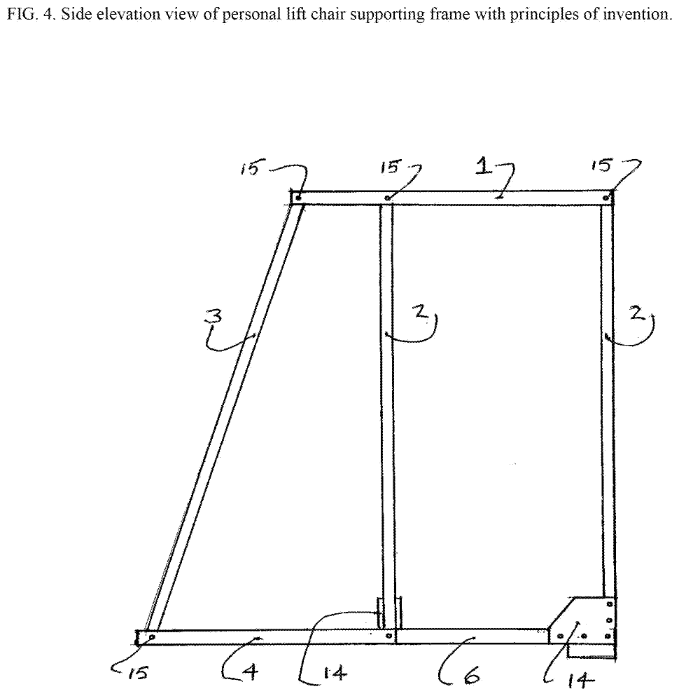

FIG. 5 Plan view of personal lift chair top frame in accordance with principles of invention.

FIG. 6 Plan view of personal lift chair lifting frame in accordance with principles of invention.

FIG. 7 Elevation view of personal lift chair lifting frame in accordance with principles of invention.

FIG. 8 Plan of Base assembly of personal lift chair in accordance with principles of invention.

FIG. 9 Elevation of Base assembly of personal lift chair in accordance with principles of invention.

FIG. 10 Perspective view of airbag/bladder assembly in accordance with principles of invention.

FIG. 11 Elevation view of guide roller assembly in accordance with principles of invention.

FIG. 12 Perspective view of auto-locking mechanism in accordance with principles of invention.

FIG. 13 Perspective view of frame attachment brackets in accordance with principles of invention.

FIG. 14 Perspective of top guide rail and support strut bracket in principle of invention.

FIG. 15 Elevation of Personal Lift chair with Sliders in accordance with principles of invention.

FIG. 16 Control schematic to operate personal lift chair in accordance with principles of invention.

### DETAILED DESCRIPTION

In one embodiment, personal lift chair comprises a supporting base frame, an intermediate supporting lift chair frame above the base frame, a single cylindrical elevating airbag/bladder extending between the base frame and the intermediate lift chair frame, at least three vertical guide rails extending between the base frame and the intermediate lift chair frame and peripheral to the elevating airbag/bladder. The vertical guide rails are connected to the upper supporting frame. The lift chair supporting frame is positioned above the supporting base frame. A backrest is attached to the rear side of the lift chair seat by one or more hinges, allowing the backrest to translate between a closed position as necessary. The personal lift chair is light-weight and can be easily moved to preferred locations. At least one pair of rollers may be included at the rear of the base frame to enable relocation, but this is not necessary. By inflating the elevating airbag/bladder, the lift chair frame translates from a lowered position flush with the floor to a fully elevated raised position. The base frame is designed with a small adjustable tilt angle to facilitate easy transition from the seat in the fully elevated position. The fully elevated height is configured such that the user can have their legs under them and fully extended with little or no bend at the knee such that they can stand upright from the fully elevated personal lift chair. The lift chair seat is designed with a forward tilt angle facilitating easy exiting from the lift chair when fully elevated.

It is therefore an object of the present invention to provide a personal lift chair to assist users in translating from a floor seated position on a floor to an upright, standing position without the necessity for additional assistance. The lift chair light weight permits the lift chair to be made mobile for voice controlled/operated relocation to site where a user requires assistance from a fall.

These and other objectives and advantages of the present invention will become apparent from a reading of the attached specification and claims. There has thus been outlined, in a broad sense, the more important features of the invention in order that the detailed description thereof that follows may be better understood, and in order that the present contribution to the art may be better appreciated. There are features of the invention that will be described hereinafter and which will form the subject matter of the claims appended hereto.

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed is a personal chair lift for assisting users in transitioning from a position seated on a floor to fully upright standing position. The device is light weight and can be located for convenience to many locations within the end user's residence or application. The device utilizes a single elevating airbag/bladder to raise the lift chair assembly from the floor to an elevated or raised position. The lift chair assembly includes a small tilt angle to permit easy transition from the lift chair seat to the standing position. The personal lift chair is designed with significantly fewer parts and a less complex structure for supporting and elevating the user from a floor position to a standing position.

The disclosed subject matter is described with reference to the drawings, wherein like reference numerals are used to refer to like elements throughout. In the following description, for purposes of explanation, numerous specific details are set forth to provide a thorough understanding of the various embodiments of the subject disclosure. It may be evident, however, that the disclosed subject matter may be practiced without these specific details. In other instances, well-known structures and devices are shown in block diagram form to facilitate describing the various embodiments herein.

In addition, the term “or” is intended to mean an inclusive “or” rather than an exclusive “or.” That is, unless specified otherwise, or clear from context, “X employs y or z” is intended to mean any of the natural inclusive permutations. That is, if X employs y; X employs z; or X employs both y and z, then “X employs y or z” is satisfied under any of the foregoing instances. Moreover, articles “a” and “an” as used in the subject specification and annexed drawings should generally be construed to mean “one or more” unless specified otherwise or clear from context to be directed to a singular form.

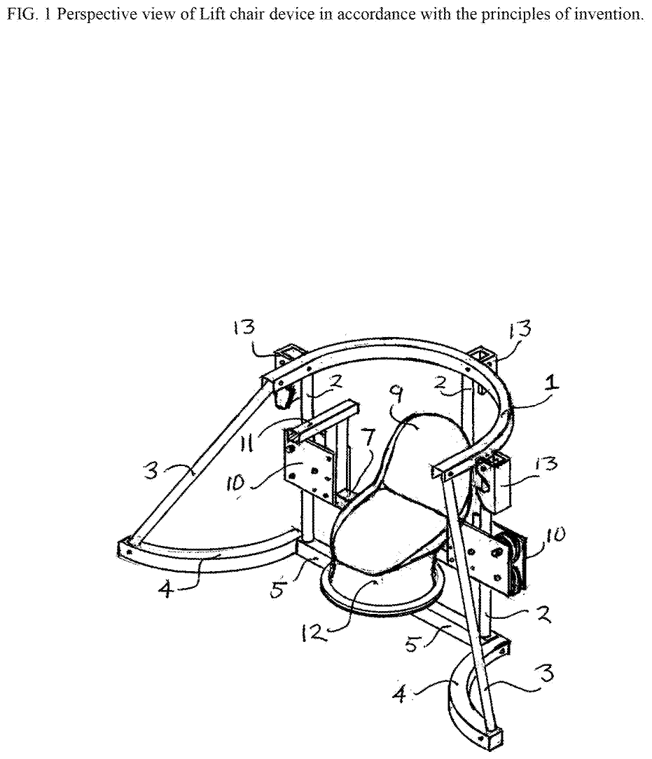

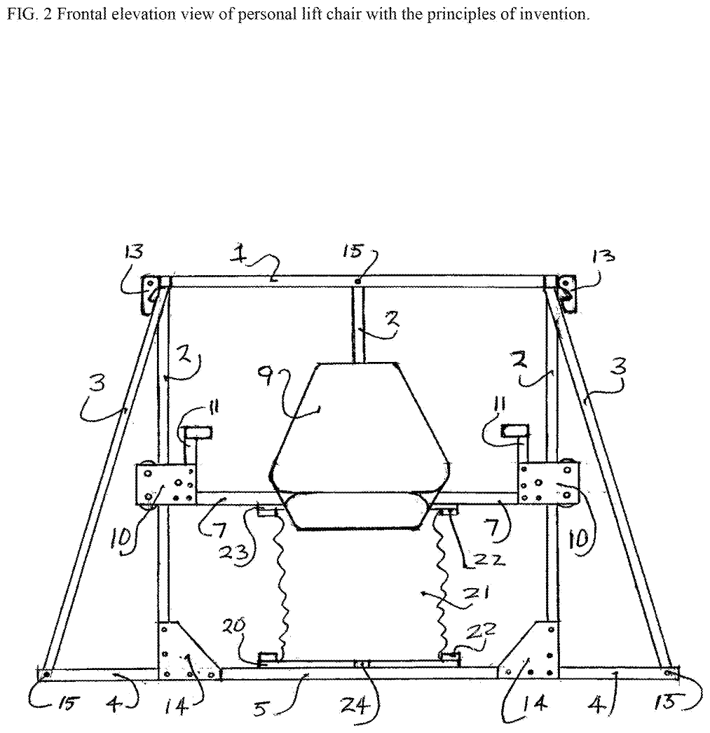

FIGS. 1, 2. and 3. shows the general embodiment of the personal lift chair illustrating the principles of the invention. The design top frame assembly is composed of a supporting frame member 1 and vertical guide rails 2 and support structs 3. The top frame section is a semi-circular frame 1 with tangential extension at each end providing additional support for the frame and attachment location for the diagonal oriented structural support members. The vertical guide rails 2 are attached at three locations along the semi-circular frame at 90 degrees intervals.

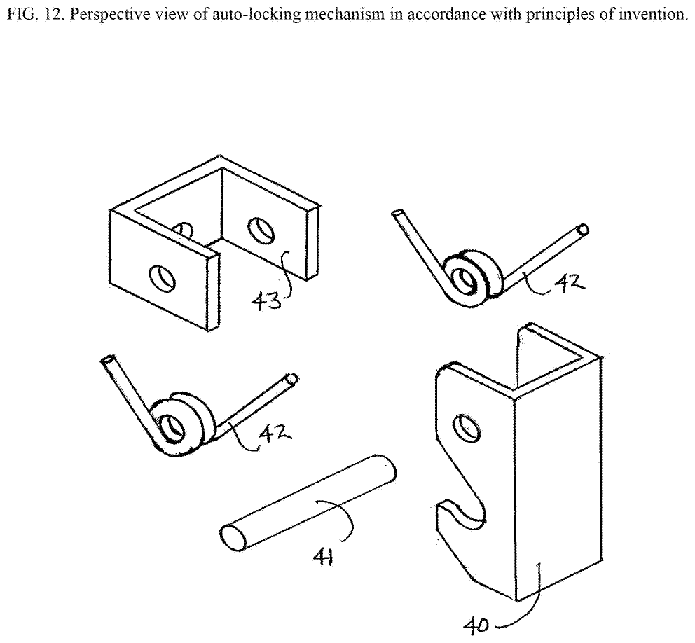

An auto-latching safety mechanism 13 shown in FIG. 12. is located at the frame top where the vertical guide rails attach to the top frame at opposite sides of the frame, 180 degrees apart. The auto-latching mechanism utilizes both the latch body 40 center of gravity and torsional springs 42 to provide a closing force when activated by the guide rail roller assembly 10 at the fully elevated position. The auto-latch assembly is attached to frame 1, using bracket 43. A guide pin, 41 is used to complete the assembly. This prevents the lift chair assembly from descending back to the initial starting position, until the latches are manually released. The top frame is also supported by struts 3 at the extended ends of the top frame 1.

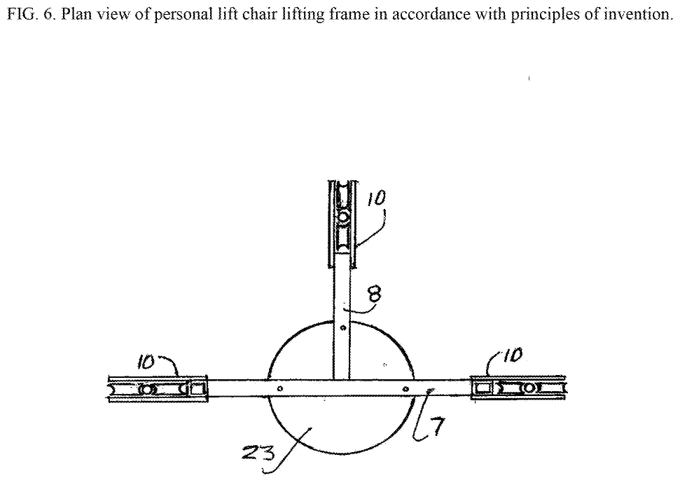

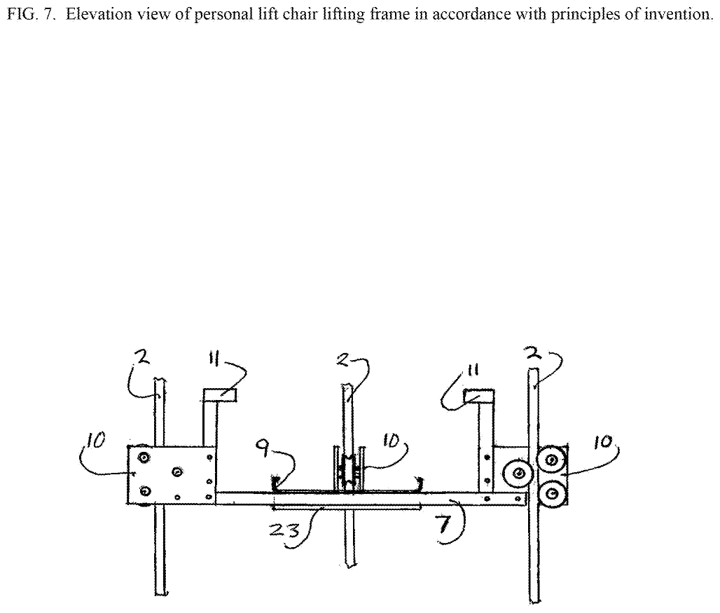

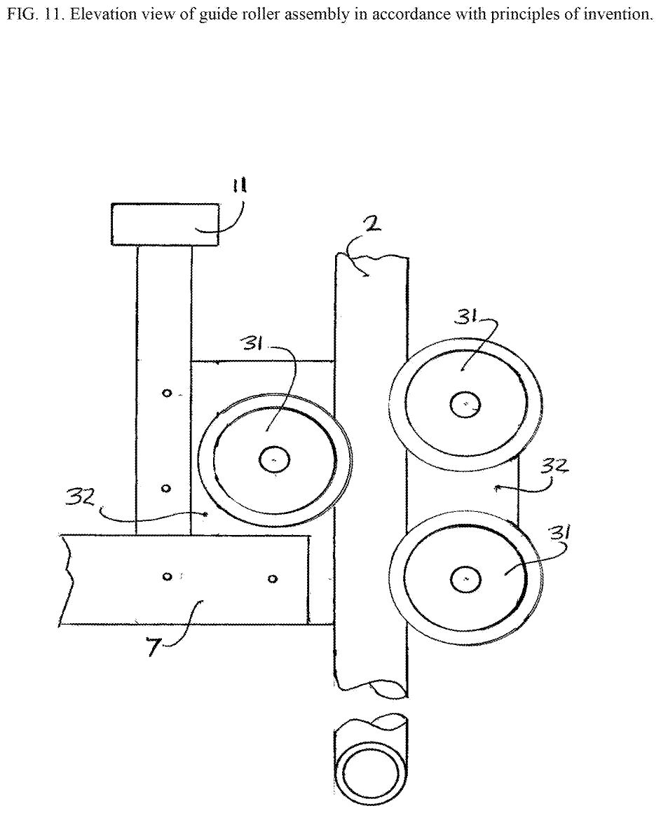

The lift chair frame assembly shown in FIGS. 6 and 7 is composed of transverse support members 7, 8 a top plate 23 and three guide roller assemblies 10 detailed in FIG. 11. located at the end of each transverse member 7, 8, the lift chair seat 9 and support handrails 11 located on the transverse members at 180 degrees. The lift chair seat 9 is attached and supported by the transverse members. The airbag/bladder top plate 23 is connected to the under-side of the transverse members of the lift frame assembly providing a lifting force for the lift chair frame assembly. The lift chair seat 9 is connected to the upper side of the transverse members 7, 8 of the lift chair frame assembly. The personal lift chair assembly frame shown in FIGS. 6, 7 is connected to the vertical guide rails 2 at the three locations with a guide roller assembly 10. [The guide roller assembly can be replaced in another embodiment of this design with low friction sliders and provide the identical function as described.]

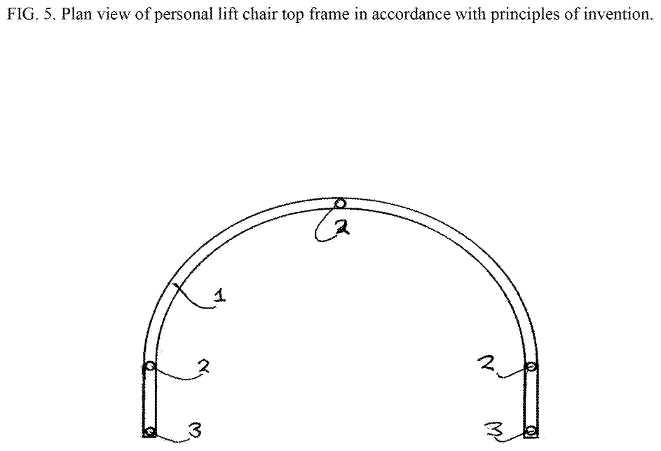

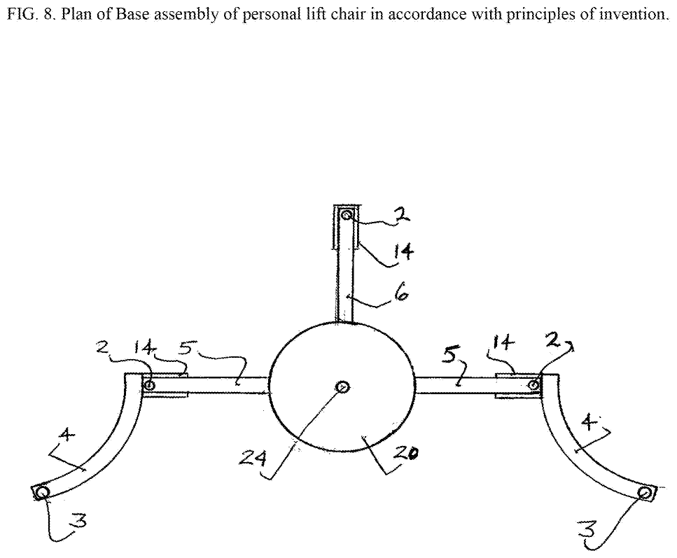

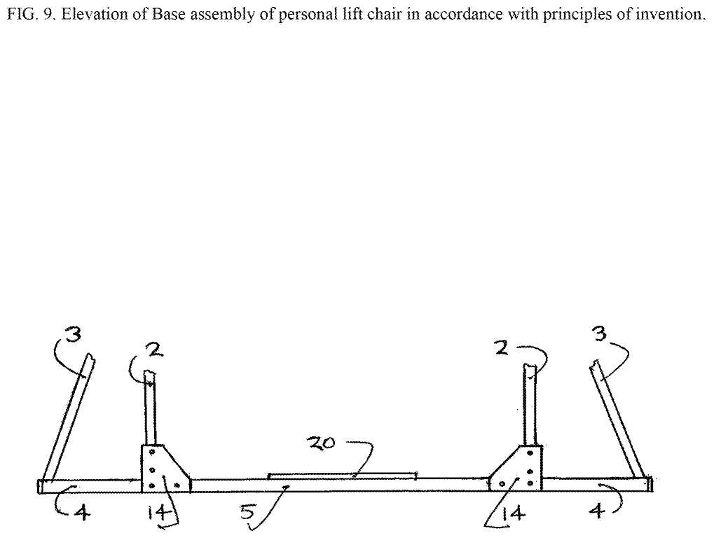

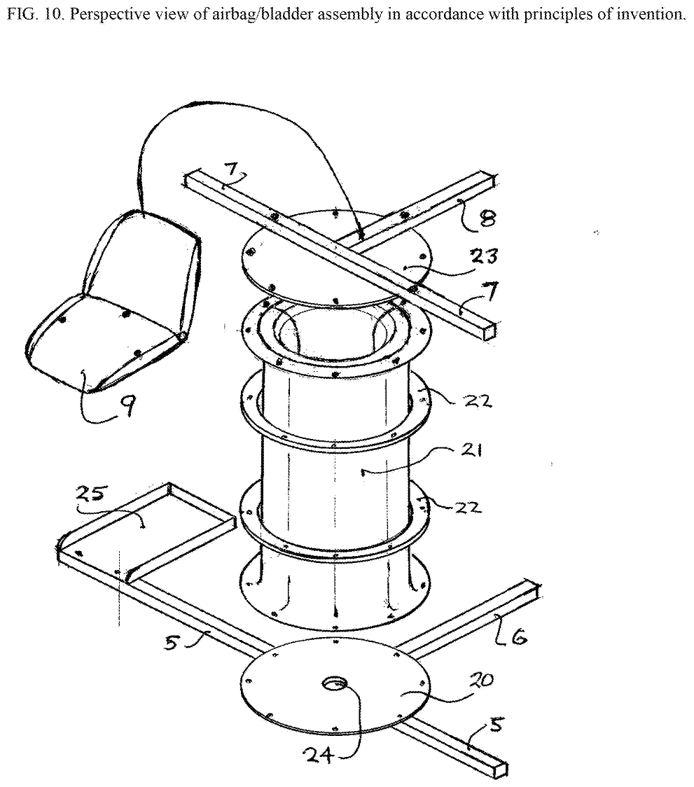

The guide roller assembly 10 detailed in FIG. 11. is attached to the lift chair frame shown in FIGS. 6 and 7 and supports the lift chair 9 as the airbag/bladder assembly 12 detailed in FIG. 10. is inflated to the fully elevated position, maintaining a stable platform during the lifting process. The base frame assembly detailed in FIGS. 8 and 9 is connected to the top frame member 1 detailed in FIG. 5. with the vertical guide rails 2 and the structural transverse support members 3. The lift chair seat 9 is designed to have a small sloping angle to provide easy entrance and exit to the lift chair seat. This is designed to minimize the effort to slide into the chair seat when the chair is at floor level and to minimize the effort to slide out of the chair seat when the lift chair is at the fully elevated position.

The airbag/bladder assembly 12 detailed in FIG. 10., a cylindrical configuration, is composed of a top mounting plate 23, retaining rings 22, airbag/bladder 21 and bottom mounting plate 20. The top plate 23 is attached to the underside of the lift chair supporting frame detailed in FIGS. 6. and 7. to members 7,8, the bottom plate 20 is attached to the upper side of the base frame assembly detailed in FIGS. 8. and 9. to transverse members 5, 6. The airbag/bladder 21 is attached to the upper and lower plates 23, 20 using the mounting rings 22. A seal is placed between the mounting plates 23,20 and the airbag/bladder 21, and the mounting rings 22 are clamped to the upper and lower plates 23, 20 completing the airbag/bladder 21 airtight seal. The airbag/bladder 21 is inflated using and low-pressure air pump. The low-pressure air pump is connected via a fitting 24 mounted into the lower plate and provides the air pressure to inflate the airbag/bladder assembly 12. The lift chair seat 9 is attached to the lift chair frame-lifting frame detailed in FIG. 6. 7. on the upper side of the transverse structural members 7,8. The airbag/bladder 21 is deflated/collapsed to return the lift chair supporting frame detailed in FIGS. 6. and 7. to the floor position. The deflation process is incorporated into the air pump configuration and occurs once the air-pump is deactivated.

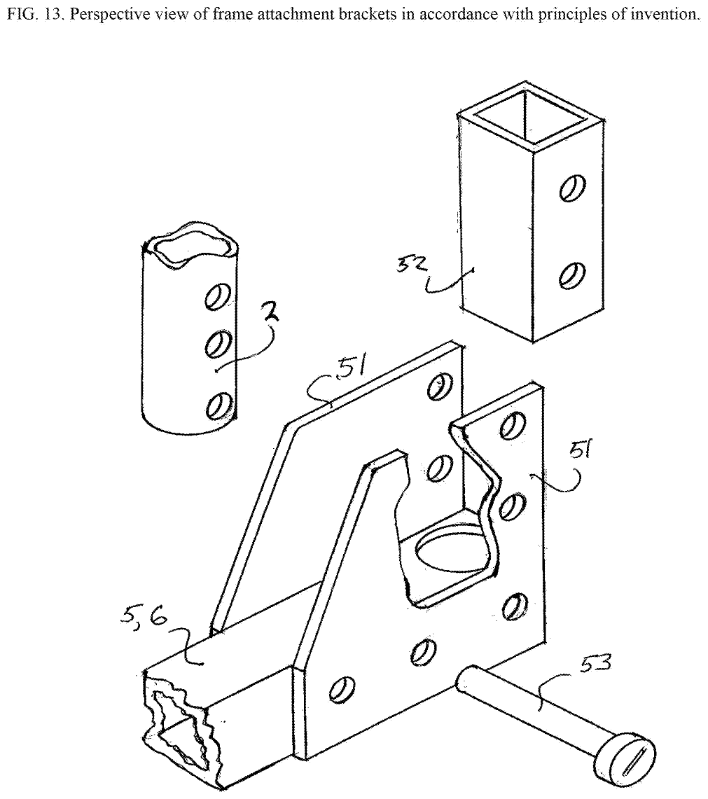

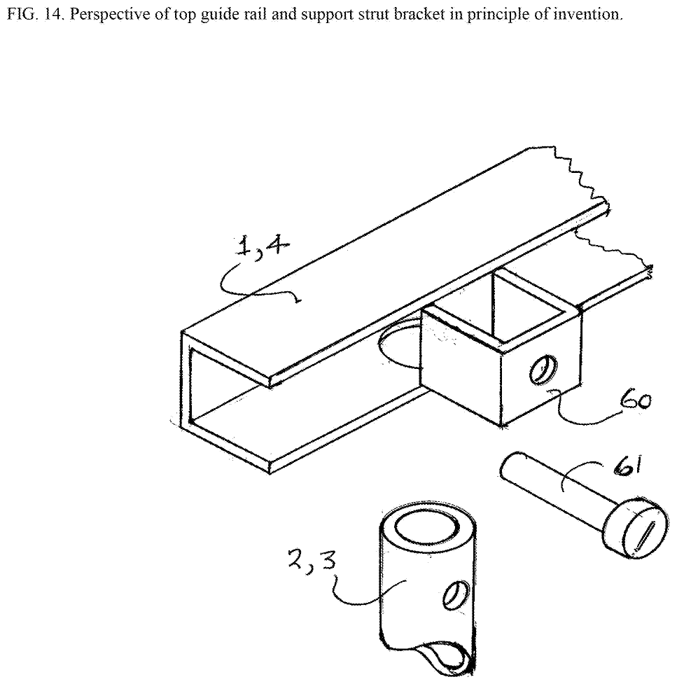

The base frame assembly detailed in FIGS. 8., 9. is composed of a bottom plate 20, transverse supporting members 4, 5, 6 mounting brackets supporting 14, 15 detailed in FIGS. 13. and 14., the vertical guide rails 2 and the diagonal structural support member 3. The base frame assembly connects the vertical guide rails 2 and the diagonal structural members 3 to the top frame assembly detailed in FIG. 5. providing a stable frame supporting the lift chair frame assembly detailed in FIGS. 6. and 7. and the lift chair seat 9. The frame base bracket 14, FIG. 13, contains plates 51, sleeve 52 and typical assembly pin 53, which are assembled to member 5, 6 and 2. Support bracket 15, FIG. 14, contains mounting bracket 60 and assembly pin 61, which are assembled to frame member 1 and 4 connecting vertical support members 2 and 3. The base frame has an adjustable angle plate located at the end of the base frame supporting member. This functions to increase or decrease the frame angle to permit easy access to the lift chair seat at the floor level. The bottom plate 20 contains a threaded port 24 for the attachment of fitting that permits pressured air to be supplied to the airbag/bladder 12 via an electrically operated low pressure air pump. The air pump can be either electrically powered via 120 VAC or 12 VDC battery supply.

The airbag/bladder 21 is inflated as the pressure increases providing the vertical lifting force to elevate the lift chair frame assembly detailed in FIGS. 6., 7. from the floor level to the fully elevated up right standing position. The pressure increase develops the lifting force to provide the vertical lift required to assist the user from the floor seating position to the upright standing position.

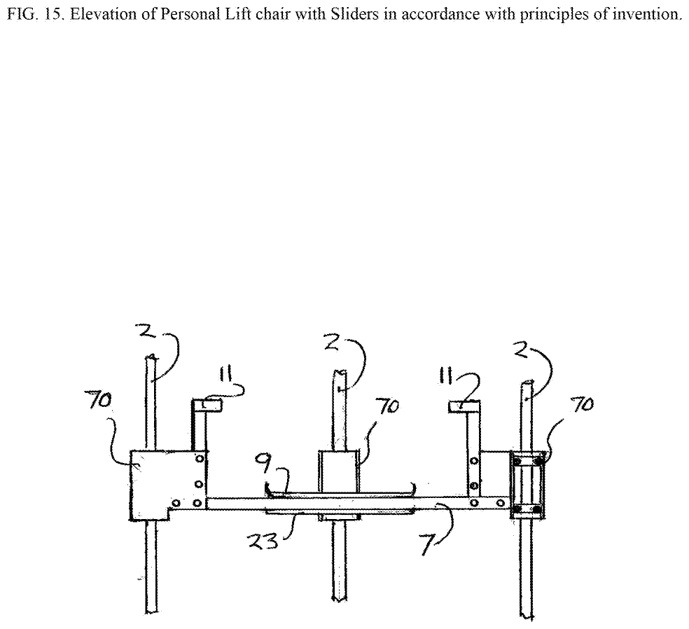

FIG. 15. provides an illustration of an alternate configuration as mentioned that includes the replacement of the roller assembly with a low friction slider assembly 70.

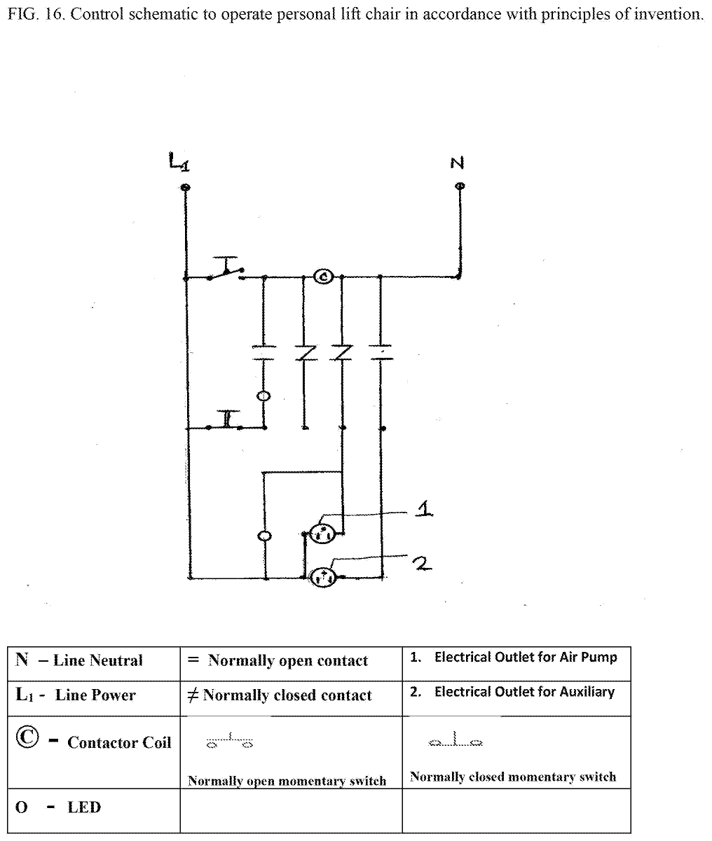

FIG. 16. is a schematic diagram that represents the control system that is used to operate the personal lift chair (Control System Configuration). The operation is initiated using a push-button once the user is located on the lift chair seat 9. The lift chair seat 9 will be elevated to the upper most level and stop at the top frame member. The auto-latching assemblies 13 will be activated preventing the unintentional lowering of the seat. The airbag/bladder 21 inflation via the air-pump operation will be terminated at the full pressurization setting pressure defined by the user. The user can reset the lift chair to the original floor level, by manually releasing the auto-latching assemblies. The control system will activate a ready-light when the lift chair is returned to the initial starting position at the floor level. The full elevation of the lift chair assembly can alternatively be controlled by proximity sensors methods, for example, magnetic reed relay sensors. The schematic diagram, FIG. 16, includes a simplified legend for the components that are part of the control system.

An inflatable and collapsible elevating airbag/bladder 21 extends from the base frame assembly detailed in FIGS. 8., 9. to the lift chair frame assembly detailed in FIGS. 6., 7. as detailed in FIG. 10. The elevating airbag 21 is substantially cylindrical and when fully inflated its top and bottom ends are maintained in a parallel configuration. The elevating airbag 21 may optionally take other configurations such as a hexagon or a square so long as the top and bottom ends of the airbag are parallel when fully inflated. An air pump assembly is attached to shelf 25 located on the base frame assembly detailed in FIG. 10. The personal lift may be raised and lowered by inflating and deflating the elevating airbag 21. The lift chair assembly frame detailed in FIG. 6.,7. is positioned directly above and parallel to the base frame assembly detailed in FIG. 8.,9.

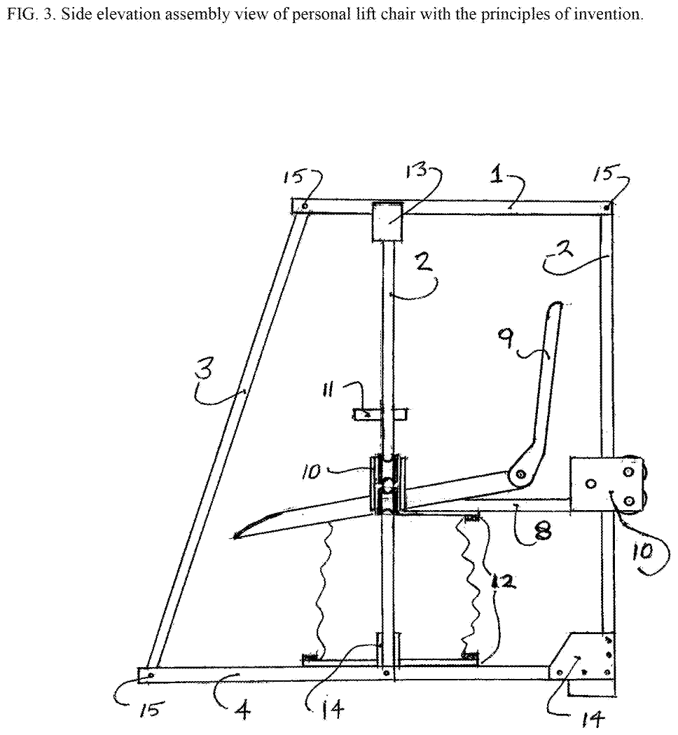

FIG. 1.,2.,3., show the details for accessing the lift chair seat. The handrails 11 are oriented to assist during the elevation process and connected to the lift chair assembly to assist a user in achieving a standing position. A user may utilize the lift chair assembly to go from a standing position to a position on the floor in a similar manner opposite to that explained above. Additional steps in the process are necessary for this to occur. The user positions themselves on the chair 9 with their back toward the backrest of the chair 9. Once seated and positioned on chair 9, the user engages the air pump to inflate the elevating airbag/bladder 21. The elevating airbag/bladder 21 slowly inflates, thereby raising the lift chair frame assembly detailed in FIGS. 6.,7. upward from the base frame assembly detailed in FIGS. 8.,9. The guide rails 2 and guide rollers assemblies 10 stabilize the lift chair frame assembly and the base frame assembly as the lift chair assembly is elevated. When the lift chair shown in FIG. 3., is fully raised, the chair is slightly tilted approximately 10 to 15 degrees.

Whereas the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

The invention claimed is:

1. A personal lift chair comprising in combination:
a. a base supporting frame for resting upon a floor when the personal lift chair is in use, composed of stationary supporting members located peripherally on 3 sides of the base frame providing enhanced user safety with a wider base footprint for increased stability.
b. an intermediate lift chair supporting frame located between the base supporting frame and the top supporting frame, elevated by a single cylindrical airbag/bladder positioned between the base supporting frame and the vertically moveable lift chair supporting frame.
c. peripherally located guide rail members extending vertically around the perimeter at 3 locations, 90 degrees apart and having upper and lower opposing ends, both fixed into the base supporting frame assembly and the top supporting frame assembly respectively.
d. a vertically moveable personal lift chair frame supporting the user of the personal lift chair including:
i. a structural frame composed of supporting transverse members, an upper mounting plate positioned below the structural supporting frame transverse members.
ii. guide roller or slider assemblies positioned at the outer ends of each transverse structural supporting frame members at 3 locations 90 degrees apart.
iii. a lift chair seat attached to the upper side of the structural support movable lift chair frame.
e. a single cylindrical pneumatic airbag/bladder extendable from the supporting base frame to the vertically movable personal lift chair frame, attached by mounting plates to the underside of the movable personal lift chair frame and the top side of the base supporting frame respectively.
f. the single cylindrical pneumatic airbag/bladder being attached to the topside of the structural supporting base frame by a mounting plate for vertical movement and by a second mounting plate connected at the underside of the personal lift chair movable frame. The single cylindrical pneumatic airbag/bladder and supporting vertical guide rail members provide for stable vertical movement there through as the personal lift chair frame moves from the initial position to the fully elevated position.
g. a mechanically simplified design for easy unassisted use by a single user.
h. a mechanically simplified design with an integral seat tilt angle to facilitate easy entrance and exit to the personal lift chair seat.
i. a mechanically simplified design that utilizes a single airbag/bladder to acquire sufficient elevation enabling the user to slide forward to a standing position with legs fully extend under the user, without assistance.
j. a mechanically simplified design that utilizes integral adjustable handrails that can be made adjustable from the normal arm rest position up to the user armpit for support.
k. a lightweight personal moveable lift chair weighing less than 35 lbs.
l. an adjustable integral lift chair tilt angle provided by the chair seat fixed inclination angle and the base frame adjustment plate.
m. an auto safety latch mechanism preventing unintended or accidental airbag/bladder deflation.
n. an auto safety latch mechanism that requires a manual reset to return the lift chair to normal position at floor level when the airbag/bladder is deflated.
o. a user operated personal lift chair designed for use without assistance from other personnel. The personal lift chair as designed returns to the floor level position when the airbag/bladder is deflated, and the auto latch mechanism is released manually. Lifting capable of up to 400 lbs.
p. an auto stop/reset control system to operate the personal lift chair composed of:
i. a single air pump system.
ii. a normally open or normally closed pressure switch for air pump control. Configuration dependent on the control system design.
iii. a double pole double throw power control relay.
iv. a controlled electrical outlet integral with the auto/reset control system.
v. a platform attached to the base supporting frame to hold the air pump and control system components.
vi. an auxiliary indicator light system indicating the ready to operate state.
vii. an auto/reset/on starting button to initiate the elevation process.
viii. interconnecting pneumatic tubing connecting the air pump to the airbag/bladder base plate fitting and the pressure switch.
q. Designed to include collapsible wheels permitting easy travel on floors. When a user enters the lift-seat the wheels retract, and the base frame contacts the floor- resisting further movement.
r. Designed to include voice actuated mobile locator operation. Device on powered wheels travels the user required location. User calls lift chair to come to location for assistance.
s. Design airbag/bladder capable of being inflated via air pump electrical model [AC or DC] or via pressurized compact cylinder (manually or electrically operated), attached to the base framne.
